(19) United States
(12) Patent Application Publication
(10) Pub. No.: US 2007/0251723 A1
(43) Pub. Date: Nov. 1, 2007

(54) METHOD AND APPARATUS FOR A MODULAR FIRE-BARRIER SYSTEM

(76) Inventor: William Christopher Duffy, Thornhill (CA)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/381,106

(22) Filed: May 1, 2006

(51) Int. Cl. H02G 3/08

(52) U.S. Cl. 174/483

(57) ABSTRACT

An apparatus for a modular fire-barrier system and a method for designing a fire-barrier system for specific applications. The fire-barrier system or structure comprises a plurality of fire-barrier modules, two or more support columns and one or more girts. Each of the fire-barrier modules comprises a frame which supports one or more fire-rated panels. The fire-rated panels comprise a single skin material having a thickness based on the desired fire rating for the application of the fire-barrier system. According to another aspect, a process or method is provided for designing a fire-barrier system or structure based on operational specifications including height and span, and environmental parameters, such as expected wind loads and/or potential seismic activity.

### FIELD OF THE INVENTION

The present invention relates to fire-barrier systems, and more particularly to a fire-barrier structure and a method for designing a fire-barrier system for various applications.

### BACKGROUND OF THE INVENTION

Fire is one of the most serious and common dangers faced by individuals, families and communities today. Fire can break out in homes, industrial facilities and even in office buildings.

Industrial workplaces and facilities are particularly susceptible to a fire outbreak. For example, there are specific fire hazards associated with equipment or facilities which house, use, or make flammable materials or fuels. Fire rated barriers are typically used to protect such facilities and/or equipment against fire or the spread of fire. Fire rated barriers are designed to provide containment should a fire start, for example, as a result of equipment failure. In an electrical power grid, for example, transformers are a common piece of equipment in the distribution and transmission stations. Transformers are also prone to overheating resulting in fire and/or explosions, often without a prior warning. As a result, containment or isolation of fire hazardous equipment, such as transformers in a distribution and transmission station, is a critical safety and operational concern. Typically, this involves providing a fire barrier between two or more oil-filled transformers.

Known fire protection techniques and barriers include water or chemical extenuation, large concrete barriers or significant distance placement between equipment or facilities. However, such known approaches have their own inherent problems. For example, water and chemical extinguishing methods have cost and reliability problems, and also require ongoing maintenance. Concrete fire barriers while effective are very heavy and require substantial footings and space requirements for installation. Concrete barriers are also difficult to install in existing equipment installations. Separation of potential fire hazardous equipment can be effective, but requires larger physical facilities or land area to achieve the separation in space or area between the pieces of equipment, for example, oil-filled transformers.

In view of these and other known deficiencies in the art, there remains a need for improvements.

### BRIEF SUMMARY OF THE INVENTION

The present invention provides an apparatus for a fire-resistant barrier structure or system according to one aspect, and a method for designing fire-resistant barriers based on parameters of the particular application and/or operating environment according to another aspect.

In a first embodiment, the present invention provides a modular fire-barrier structure, the structure comprises: a plurality of fire-barrier modules; each of the fire-barrier modules including an element for joining a corresponding element on an adjacent fire-barrier module; each of the fire-barrier modules including one or more panels, each of the panels comprising a fire-rated material.

In another embodiment, the present invention provides a method for designing a fire-barrier structure, the fire-barrier structure comprises a plurality of fire-rated panels, a plurality of column elements and plurality of girt elements, the method comprises the steps of: inputting a length parameter for the fire-barrier structure; inputting a height parameter for the fire-barrier structure; inputting a loading parameter; determining a required number of the column elements based on the length parameter; determining a required number of the girt elements based on the length and height parameters; determining a column dimension for the column elements, the column dimension being based in part on the loading parameter; determining a girt dimension for the girt elements, the girt dimension being based in part on the loading parameter.

Other aspects and features of the present invention will become apparent to those ordinarily skilled in the art upon review of the following description of embodiments of the invention in conjunction with the accompanying figures.

### BRIEF DESCRIPTION OF THE DRAWINGS

Reference will now be made to the accompanying drawings which show, by way of example, embodiments of the present invention and in which:

FIG. 1 shows diagrammatic form a modular fire-barrier system or structure according to an embodiment of the present invention;

FIG. 2 shows diagrammatic form a modular fire-barrier structure according to another embodiment of the present invention;

FIG. 3(a) shows in diagrammatic form connection of a fire-rated panel to a member in the fire-barrier module according to an embodiment of the invention;

FIG. 3(b) shows in diagrammatic form connection of adjacent fire-barrier modules according to an embodiment of the invention;

FIG. 4 shows in diagrammatic form connection of two adjacent fire-rated panels to a support member in the fire-barrier system according to an embodiment of the invention;

FIGS. 5(a) and 5(b) show in diagrammatic form a bracket structure for connecting a girt to the fire-barrier module;

FIGS. 6(a) and 6(b) show in diagrammatic form a fire protection structure for a girt according to another aspect of the invention;

FIGS. 7(a) and 7(b) show in diagrammatic form a bracket structure for attaching a column to a girt in the fire-barrier system;

FIGS. 8(a) and 8(b) show in diagrammatic form embodiments of footing structures;

FIG. 9 shows in diagrammatic form a footing structure according to another embodiment;

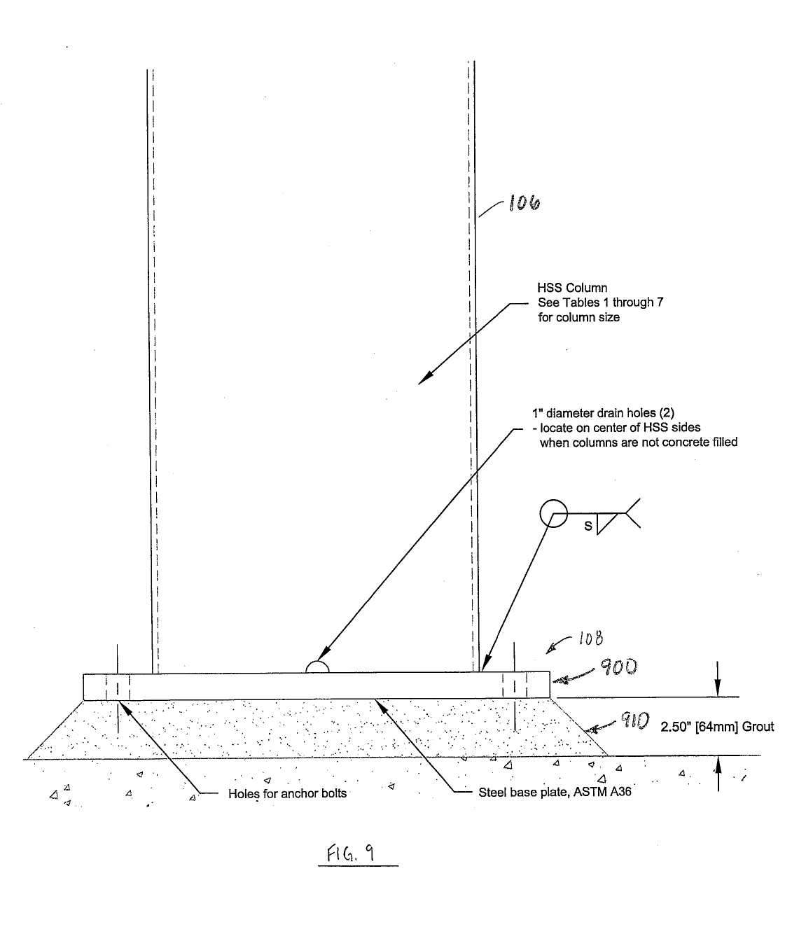

FIG. 10 shows in diagrammatic form a footing structure according to another embodiment;

FIG. 11 shows in flowchart form a method for designing a modular fire-barrier system according to an embodiment of the present invention; and

FIG. 12 provides a specification table for designing a modular fire-barrier system according to another aspect of the present invention.

In the drawings, like elements are indicated by like references.

### DETAILED DESCRIPTION OF THE EMBODIMENTS

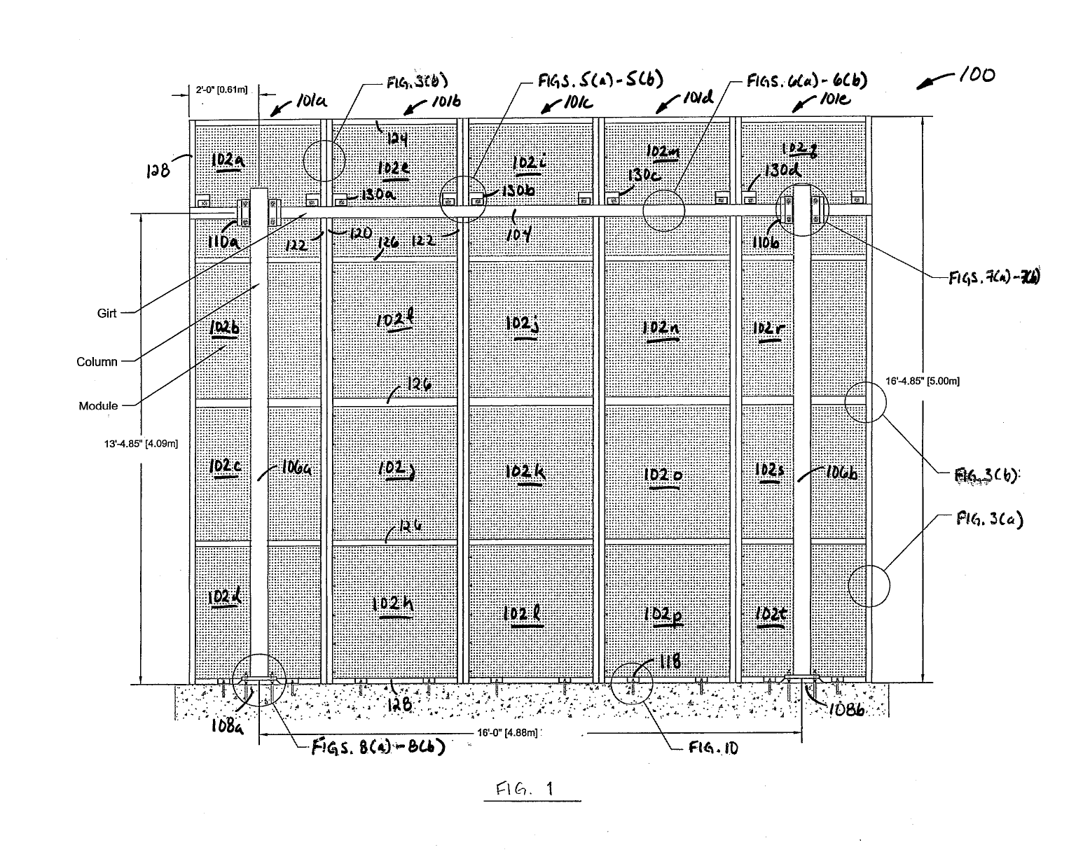

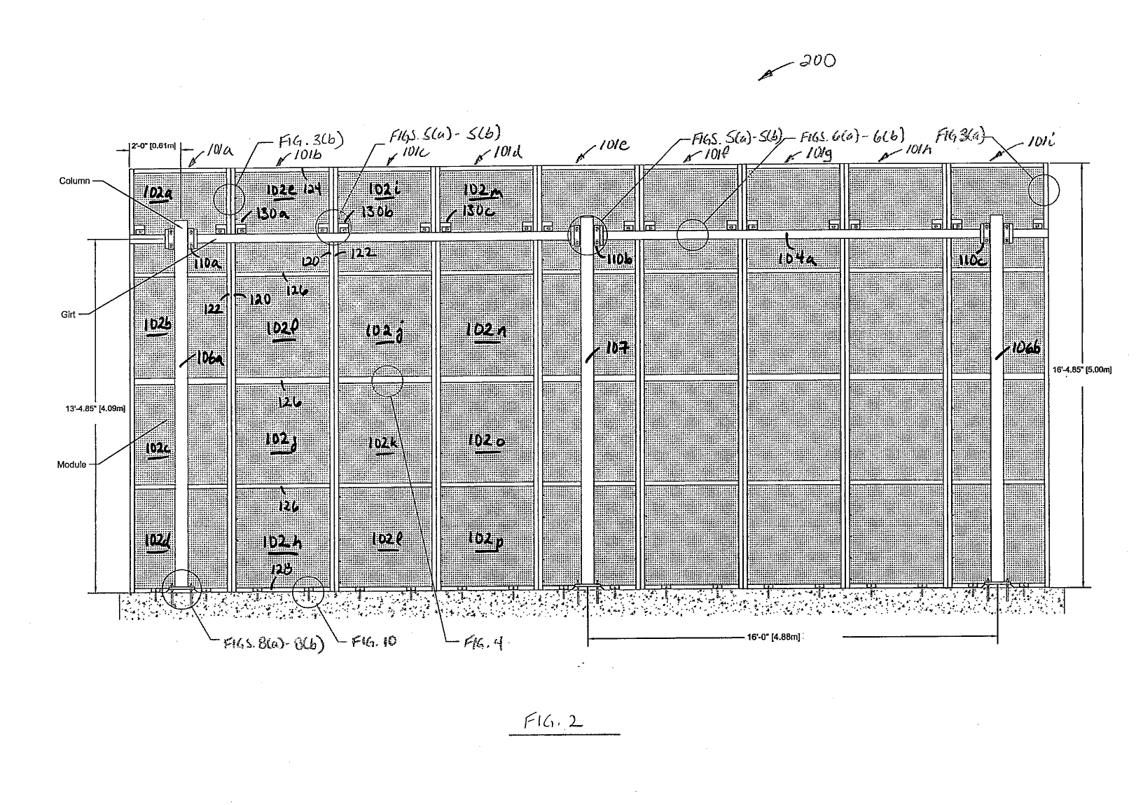

Reference is first made to FIGS. 1 and 2, which show in diagrammatic form a modular fire-barrier structure or system according one embodiment of the present invention, and indicated generally by reference 100.

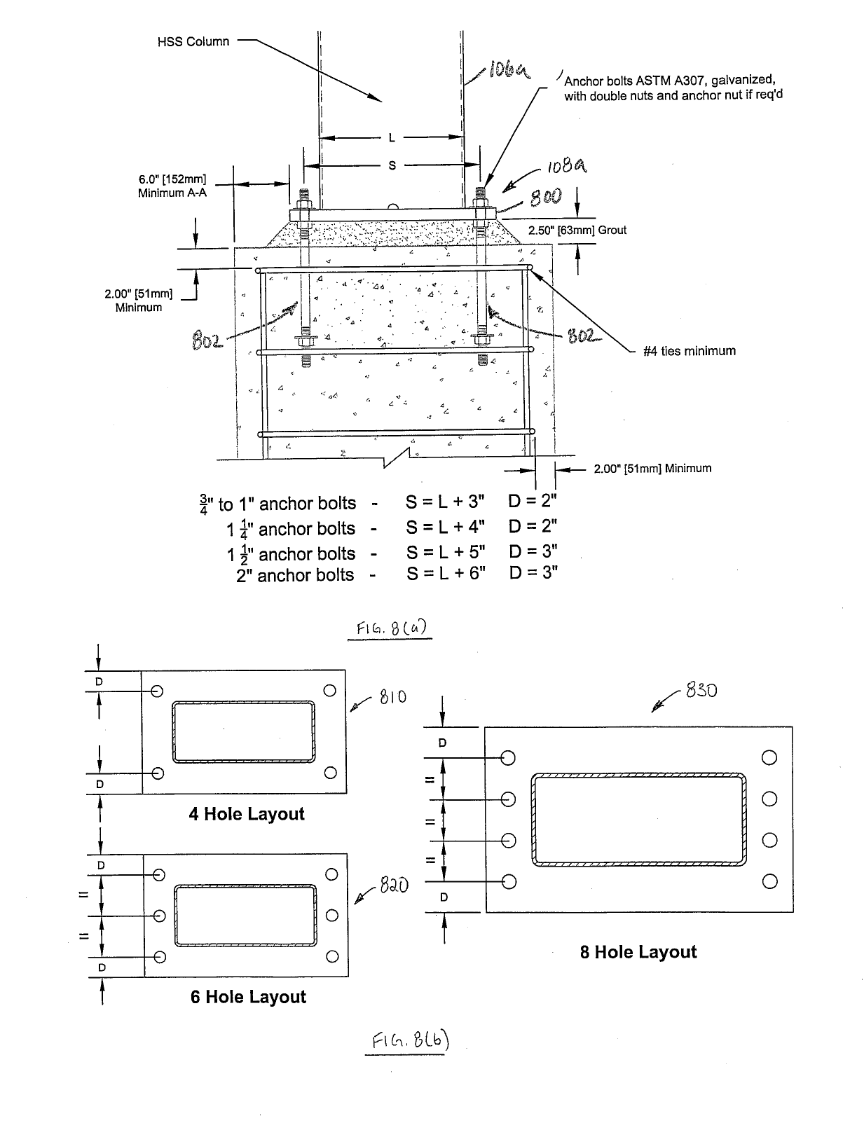

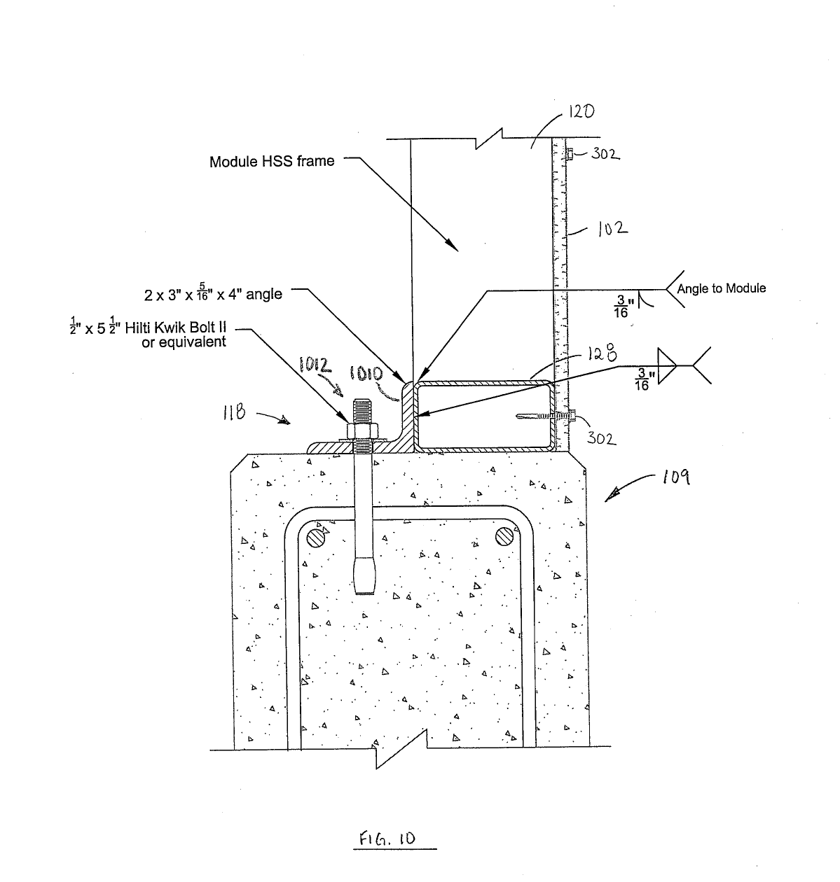

The modular fire-barrier structure 100 comprises one or more fire-barrier modules 101, one or more horizontal girts 104 and one or more columns 106. The exemplary modular fire-barrier structure 100 depicted in FIG. 1 comprises five fire-barrier modules 101, indicated individually by references 101a, 101b, 101c, 101d and 101e. The fire-barrier structure 100 also includes two columns 106, indicated individually by references 106a and 106b. The columns 106 are connected or fastened to the girt(s) 104 with brackets 110, indicated individually by references 110a and 110b in FIGS. 1 and 2. The girt(s) 104 are coupled or joined to fire-barrier modules 101 with brackets 130, indicated individually by references 130a, 130b, 130c, 130d and 130e, in FIGS. 1 and 2. Each of the columns 106 includes a footing 108, indicated individually by references 108a and 108b in FIG. 1. The footings 108 and embodiments thereof are shown in more detail in FIGS. 8(a) to 8(b). The footings 108 may be replaced by a pier structure at the foot of each of the columns 106. An embodiment of pier structure 109 is shown in FIG. 10. The utilization of footings or piers facilitates retrofitting or installing the fire-barrier 100 into existing installations or applications, such as transformer stations or sub-stations, because a continuous foundation is not needed.

As also shown in FIG. 1, each of the fire-barrier modules 101 comprises a rectangular frame having a pair of side members 120 and 122, a top member 124, and a bottom member 128. The fire-barrier system 100 depicted in FIG. 1 includes five fire-barrier modules 101, indicated individually by references 101a, 101b, 101c, 101d and 101e. The fire-barrier depicted in FIG. 2 and indicated generally by reference 200 includes nine fire-barrier modules 101, indicated individually by references 101a, 101b, 101c, 101d, 101e, 101f, 101g, 101h and 101i. The fire-barrier structure 200 also includes an intermediate column denoted by reference 107 and two girts 104a and 104b. Depending on the height of the fire-barrier 100, each of the fire-barrier modules 101 may include one or more intermediate members indicated generally by reference 126. The intermediate members 126 serve to divide the module 101 into a number of panels 102, indicated individually by references 102a, 102b, 102c and 102d for the first fire-barrier module 101a, and for the second fire-barrier module 101b, the panels 102e, 102f, 102g and 102h, for the third fire-barrier module 101c the panels 102i, 102j, 102k and 102l, for the fourth fire-barrier module 101d, the panels 102m, 102n, 102o and 102p, and for the fifth fire-barrier module 101e, the panels 102q, 102r, 102s and 102t, as shown in FIG. 1. Each of the fire-barrier panels 102 comprises a square or rectangular section of a fire-rated material. The respective fire-barrier panels 102 are welded or otherwise attached to the frame formed by the top member 124, the side members 120 and 122, the bottom member 128, and the intermediate member(s) 126, for example, using self-drilling or self-tapping screws as described below. It will be appreciated that the height of the fire-barrier 100 typically determines the number of intermediate members 126 required for a particular implementation of the fire-barrier system.

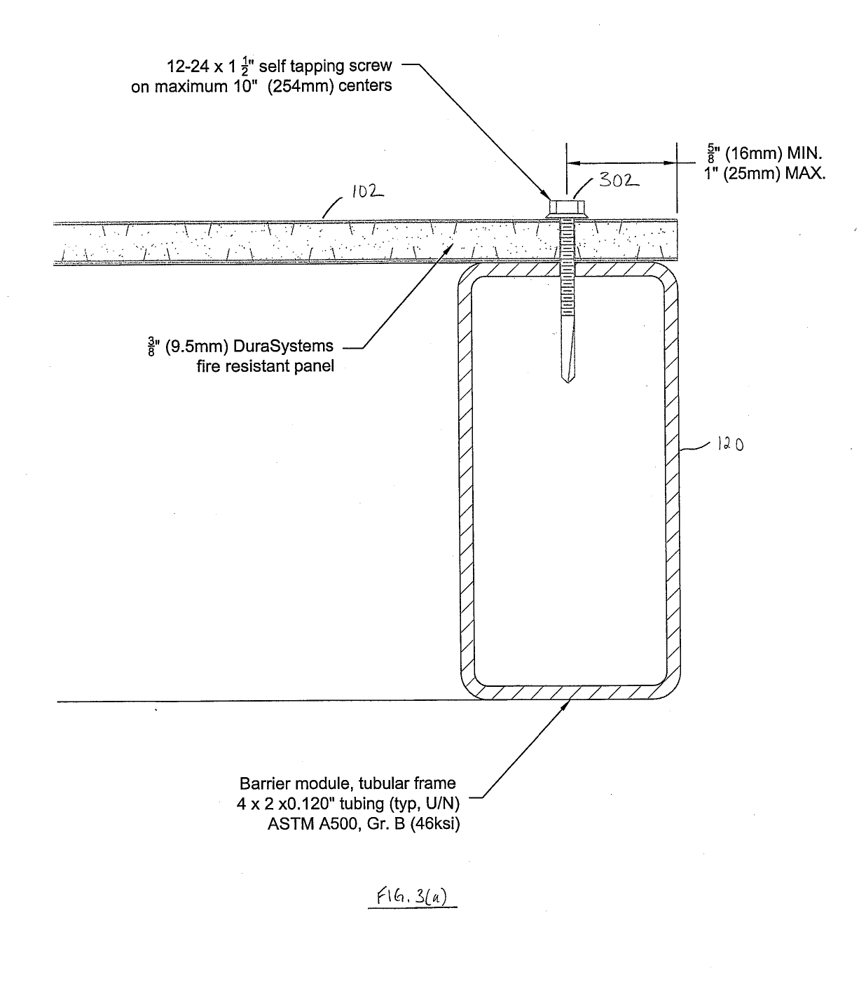

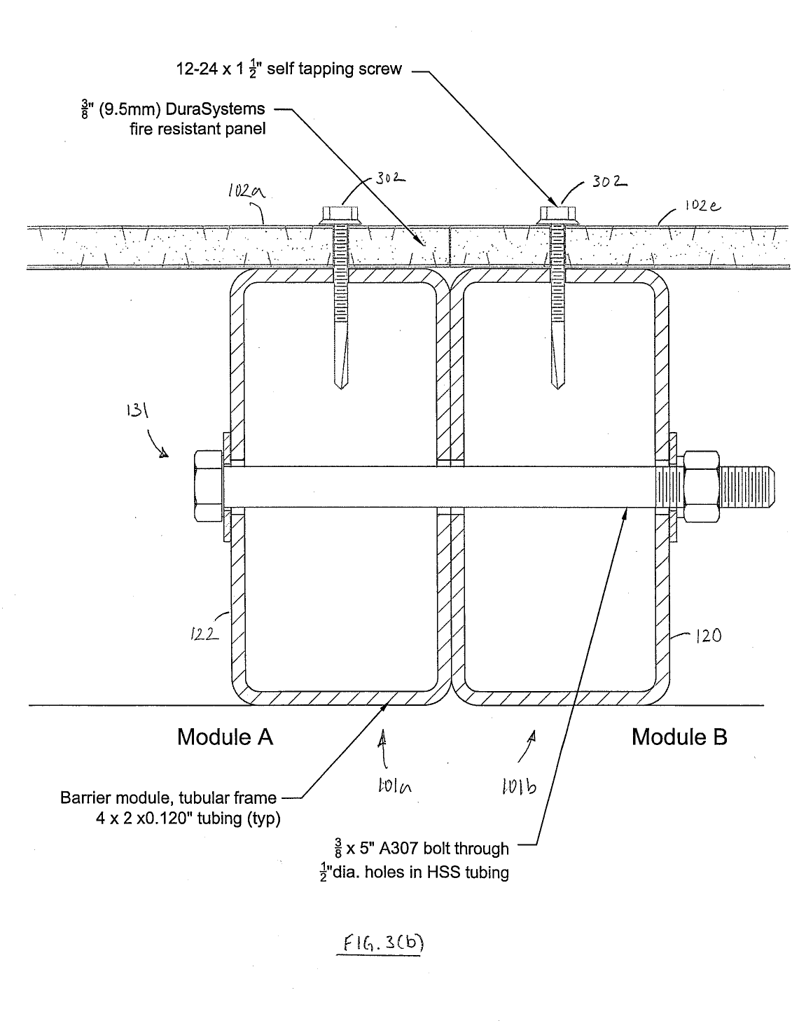

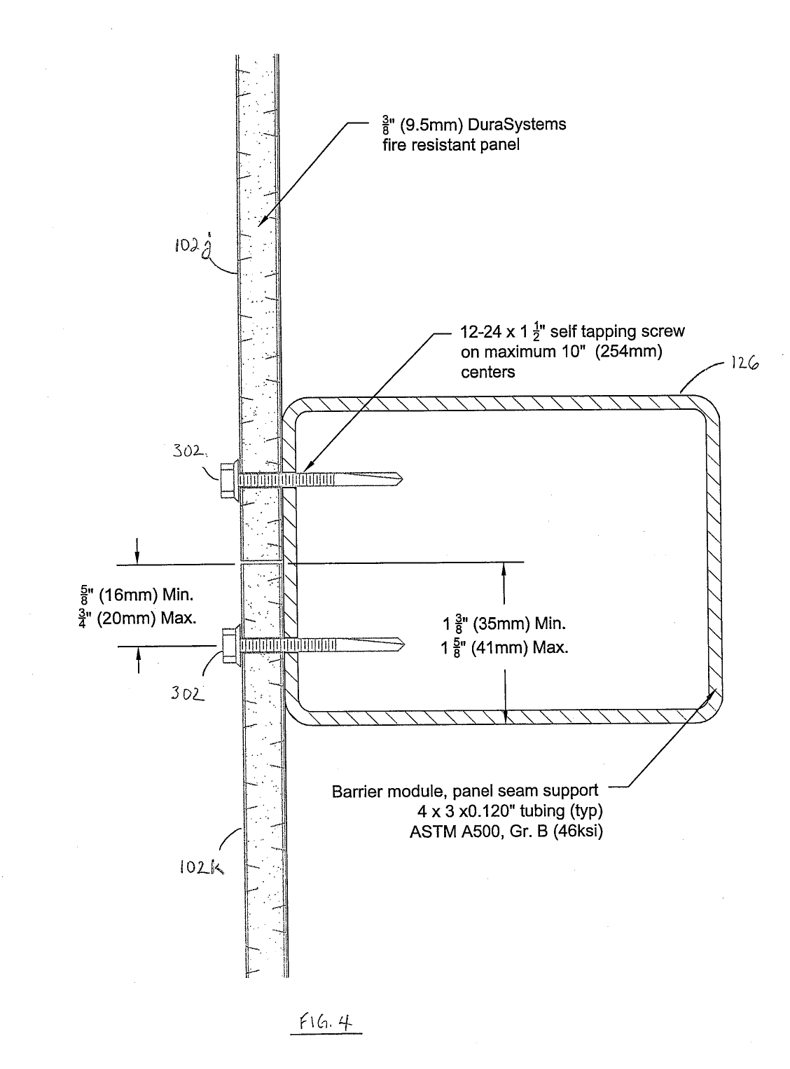

Referring to FIG. 1, the panels 102 for the fire-barrier modules 101 comprise a single skin, i.e. a single sheet or layer, of fire-rated material according to an embodiment of the invention. The panels 102 have a thickness, which is determined according to the application as described in more detail below. For example, the fire-barrier panel 102 may have a thickness ranging from ½″ to 6″. According to one embodiment, the top member 124, the side members 120 and 122, the bottom member 128, and the intermediate member(s) 126 comprise steel sections (for example, tubular frame stock) and the fire-rated panel 102 is attached to the members and welded together into rectangular structural frames, which are then hot dipped galvanized. According to one embodiment, the fire-rated panel 102 is attached to the top 124, the side 120, 122, the bottom 128 and the intermediate member 126 (if present) using self-drilling or self-tapping metal screws around the peripheral edge of each panel 102, for example, as shown in FIGS. 3(a) and 4, with the self-tapping screws indicated by reference 302. Each fire-barrier module 101 is attached to another module by means of structural bolt and nut assemblies 131 through the support steel, for example, as shown in FIG. 3(b).

As shown in FIG. 1, each one of the fire-barrier modules 101 is attached to the adjacent fire-barrier module to form a continuous fire barrier structure and also provide a support structure. For example, as shown in FIG. 1, the side member 122 of the fire-barrier module 101a attaches to the side member 120 of the fire-barrier module 101b, for example, using the bolt and nut assemblies 131 as shown in more detail in FIG. 3(b). In another embodiment, adjacent fire-barrier modules 101 are joined using welding. To provide additional structural support, the fire-barrier modules 101 may be welded to the girt 104 at the respective contact points. The height of the modular fire barrier 100 is a factor in determining the number of horizontal girt(s) 104.

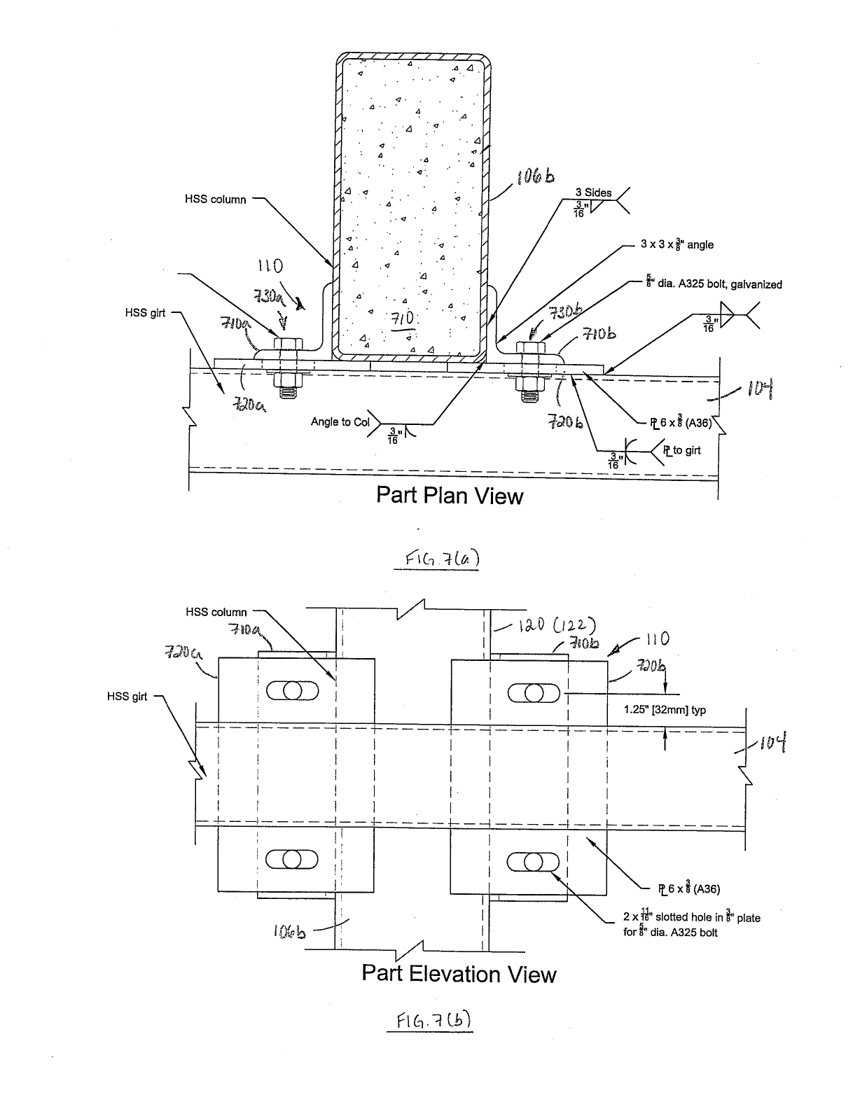

The support columns 106 and the associated footings 108 or piers are located at, or close, to the ends of the fire-barrier structure 100. According to one embodiment, the spacing of the support columns 106 is between 10 to 30 feet, i.e. on the centers. For larger barriers, one or more intermediate support columns 107 are provided. For example, as shown in FIG. 2, the fire-barrier 100 includes the intermediate support column 107. The support columns 106, the girts 104, the footings 108 and piers 109 are designed or specified to resist the local environmental factors or loads associated with the location of the application, for example, wind and/or seismic loads which are expected or anticipated in the locale of the installed fire-barrier structure 100, as described in more detail below. According to another embodiment, the support columns 106 comprise hollow members and may be filled with a fire-rated or fire-resistant material, such as concrete 710 (i.e. minimum 3000 psi) as depicted in FIG. 7, to provide additional fire protection.

Referring to FIG. 1, the columns 106a and 106b are coupled to the girt 104 at the respective contact or overlap points using brackets 110, indicated individually by references 110a and 110b. Similarly, for the fire-barrier structure 200 shown in FIG. 2, the columns 106a, 106b and the intermediate column 107 are coupled to the girt 104 at the respective contact or overlap points using brackets 110, indicated individually by references 110a, 110b and 110c, respectively. An embodiment of the bracket 110 is shown in greater in FIGS. 7(a) and 7(b). As shown, the bracket 110 comprises a first pair of brackets 710a and 710b and a second pair of brackets 720a and 720b. The first pair of brackets 710a, 710b comprise sections of angled metal and are fastened or joined (e.g. welded or bolted) to respective sides of the column 106b. The second pair of brackets 720a and 720b comprise plates, which are fastened, for example, welded to the girt 104, in a spaced relationship that corresponds to the position of the brackets 710a and 710b. The brackets 710 include matching holes which are aligned with matching holes (e.g. circular or oval slots) in the brackets 720 and are fastened together with a bolt and nut assembly 730 as depicted in FIG. 7(a) in order to couple the column 106b to the girt 104.

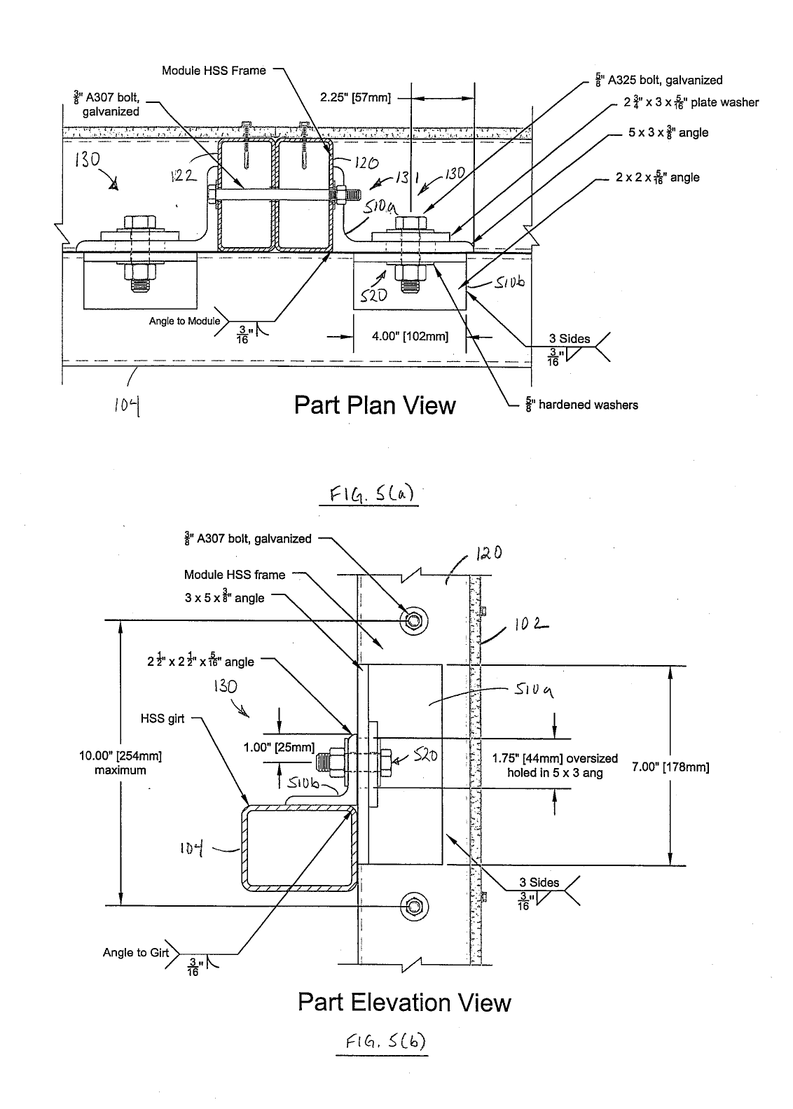

As shown in FIG. 1, the horizontal girt(s) 104 attach or are coupled to the side members 120, 122 (and the fire-barrier modules 101) with respective mounting brackets 130. The mounting bracket 130 and the connection between the girt 104 and the side members 120, 122 are shown in greater detail in FIGS. 5(a) and 5(b). As shown in FIGS. 5(a) and 5(b), each one of the mounting brackets 130 comprises a pair of angle brackets 510, indicated individually by references 510a and 510b. The first angle bracket 510a is coupled to one of the side members 120 (or 122) of the fire-barrier module 101, for example, using the fastener 131 (i.e. the bolt and nut assembly). The second angle bracket 510b is coupled to the girt 104, for example, using a welded connection or a bolted connection. The girt 104 is coupled to the fire-barrier module 101 by fastening, e.g. using a bolt and nut assembly 520, the respective angle brackets 510a and 510b together.

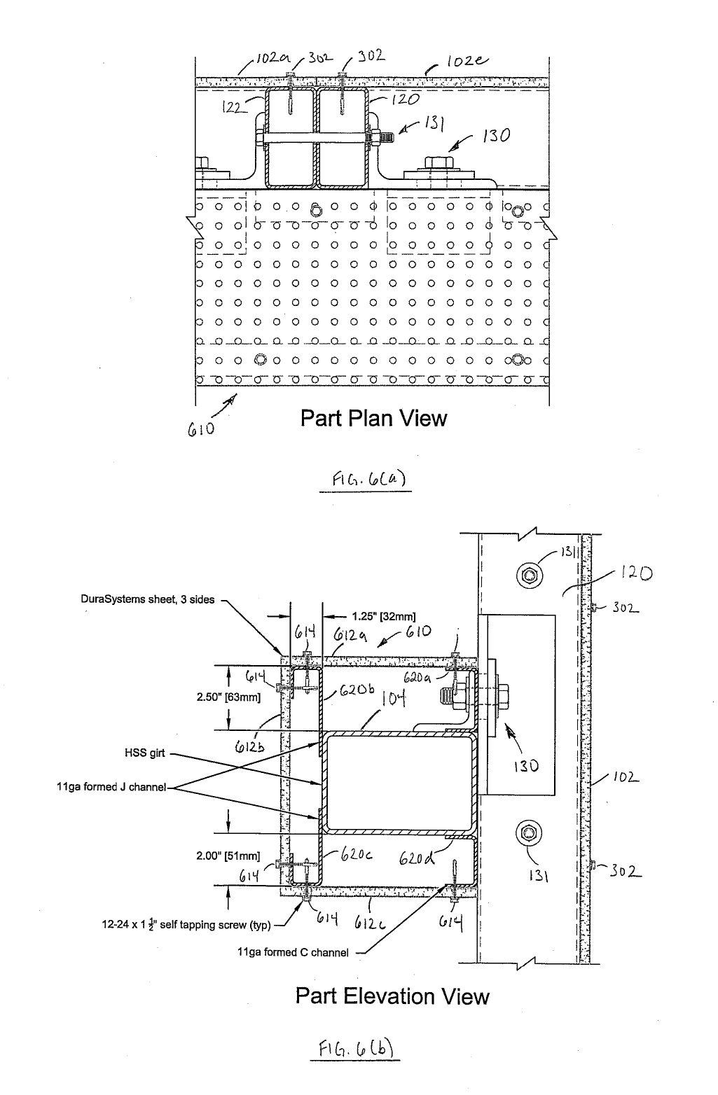

As shown in FIGS. 6(a) and 6(b), a protective cover 610 may be included to protect the girt(s) 104 against fire according to another embodiment of the invention. The protective cover 610 comprises three strips or slabs 612 of a fire-rated material, which are connected using internal together in a generally rectangular or square orientation (when viewed in cross-section as shown in FIG. 6(b)). The fire-rated slabs 612 are connected together using screws 614 (e.g. self-tapping or self-screwing) and internal brackets 620, indicated individually by references 620a, 620b, 620c and 620d, in FIG. 6(b). One of the brackets, in this example, bracket 620a is connected to a respective one of the mounting brackets 130 to connect the protective cover 610 to the fire-barrier structure 100 (as described above with reference to FIG. 1 and FIG. 5, the mounting brackets function to join the girt 104 to the fire-barrier module 101). The other brackets 620b to 620c have respective surfaces or faces, which contact the girt 104 and function to support or bear the weight of the protective cover 610. In one embodiment, one or more of the brackets 620 may be welded or otherwise joining to the respective surface of the girt 104. The fire-rated strips or slabs 612 may comprise a single skin fire-resistant material similar to that for the fire-rated material for the panels 102. The thickness of the fire-rated strips 612 is determined according to the degree or standard of fire protection sought for the fire-barrier 100.

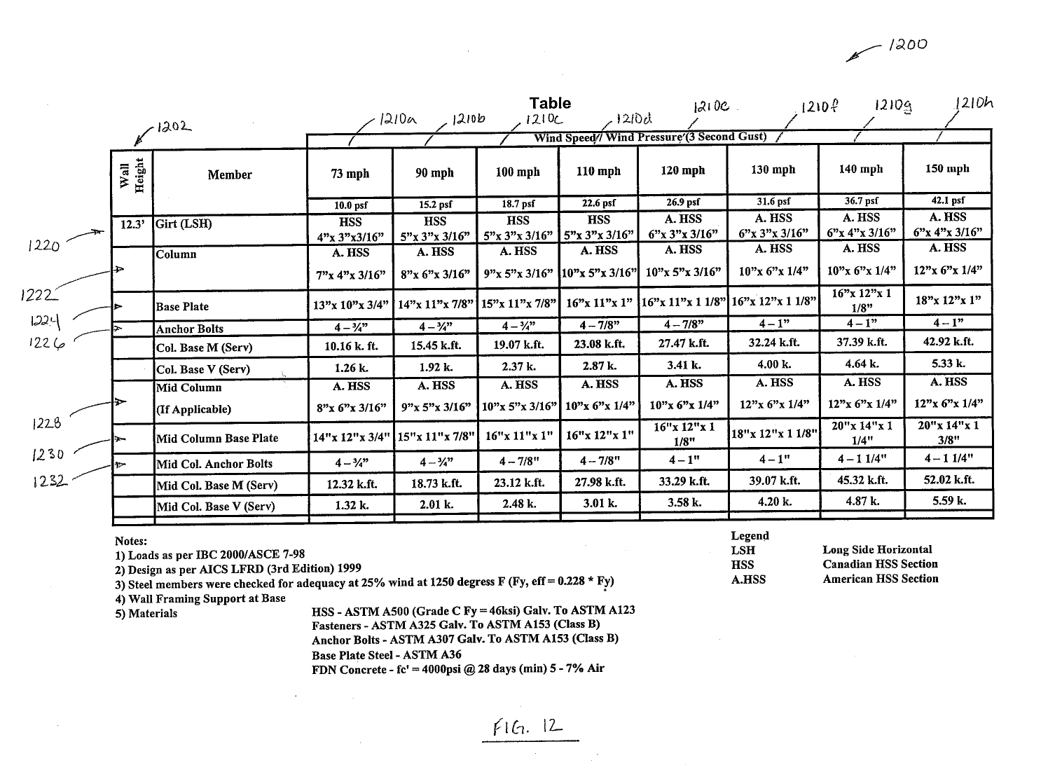

Reference is next made to FIGS. 8(a) to 8(b), which show the footing 108a in more detail. As shown, the footing 108a comprises a base plate 800 and four or more anchor bolt and nut assemblies, which are indicated generally by reference 802. As shown in FIG. 8(a), the anchored bolts 802 are buried in the foundation (e.g. concrete foundation) and may be further reinforced with an anchor structure, for example, comprising one or more ties, which are also buried. As shown in FIG. 8(b), the base plate 800 may comprise a four-hole plate 810, a six-hole plate 820 or an eight-hole plate 830. In most cases, the size of the columns 106 (and the fire-barrier structure 100) determines the size of the base plate 800 to be used, for example, as described below with reference to FIG. 12.

Reference is next made to FIG. 10, which shows in more detail the bracket 118 for connecting or fastening the bottom members 128 to the foundation. As shown, the bracket 118 comprises an angled bracket section 1010 having one face or surface joined to a side of the bottom member 128 (e.g. using a welded joint or a bolted connection). The other face of the angled bracket section 1010 rests on the foundation and is secured with an anchor bolt and nut/washer assembly 1012. As shown, the anchor bolt is buried in the foundation and secured with an anchoring device or other similar type of reinforcement.

According to another aspect, the modular structure of the fire-barrier 100 allows fabrication in a factory environment and also pre-fabrication of components or elements, e.g. the fire-barrier modules 101, for the system 100. The controlled manufacturing in a factory also leads to higher levels of quality control, which in turn, facilitates assembly/installation of the fire-barrier 100 in the field.

According to another aspect, a fire-barrier structure or system 100 is specified according to the required installation height and width of the application and fire protection, and then pre-engineered according to the environmental factors associated with the installation. The environmental factors include, for example, expected or maximum wind conditions, the presence and extent of potential seismic activity.

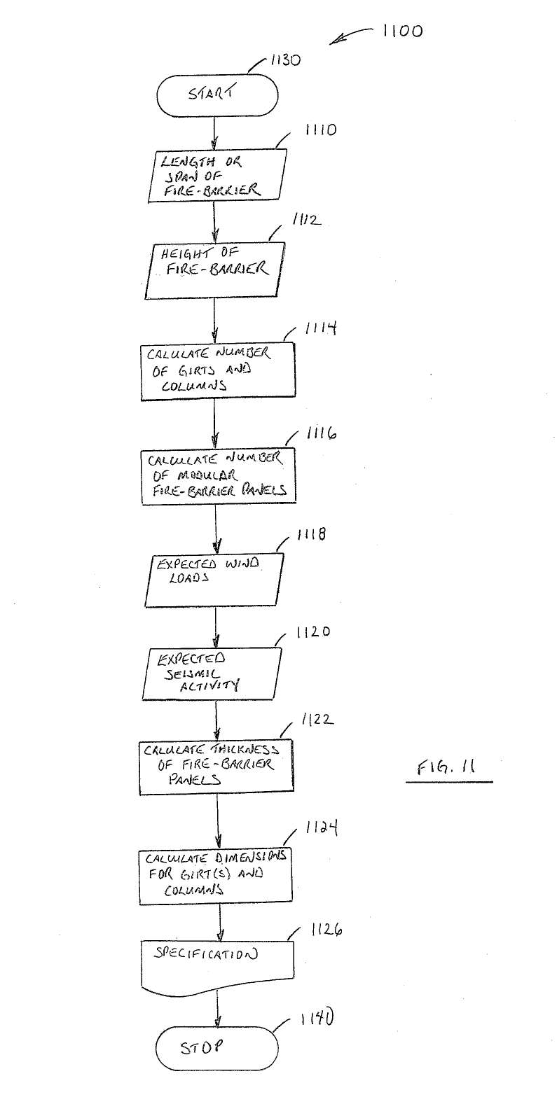

Reference is made to FIG. 11, which shows in flowchart form a process for pre-engineering or specifying a modular fire-barrier 100 according to the present invention. The process is indicated generally by reference 1100. The first two steps indicated by references 1110 and 1120 comprise specifying the length or span of the fire-barrier 100, and the height of the fire-barrier 100, respectively. Typically, the fire-barrier 100 is designed to meet the operational requirements of the specific application and fit into the physical area allocated for the fire-barrier while, for example, still allowing sufficient free air flow in a transformer application to assist in cooling. The next step, indicated by reference 1114, comprises calculating the number of columns 106 (FIG. 1) and the number of girts 104 (FIG. 1) that will be required, for example, based on the length and height of the fire-barrier 100. The next step, indicated by reference 1116, involves determining the number of fire-barrier modules 101 (FIG. 1) required for the given span. It will be appreciated that the number of modules 101 will depend both on the length of the span and also the width of the individual modules 101. According to another aspect, the fire-barrier modules 101 may be pre-fabricated in a range of standard widths and/or heights. The next step, indicated by reference 1118, involves specifying the expected wind loads for the application. The next step, indicated by reference 1120, involves specifying the expected seismic activity (if any) associated with the application site. The next step, indicated by reference 1122, comprises calculating a required thickness for the fire-barrier panels 102 (FIG. 1). The thickness of the fire-barrier panels 102 depends on both structural considerations (e.g. wind loads and/or seismic forces) and fire-protection. Once the thickness for the fire-barrier panels 102 is determined, the dimensions for the girt(s) 104 (FIG. 1) and the columns 106 (FIG. 1) are determined in step 1124. To provide additional fire protection, the columns 106 may be filled with a fire retardant material, for example concrete 710, as illustrated in FIG. 7(a), and also described above. Due to specific local soil conditions or similar considerations, the footings 108 (FIG. 1) and/or the piers (FIG. 2) typically require local engineering analysis prior to installation. The process 1100 results or generates a specification indicated generally by reference 1126. The specification 1126 provides a useful tool for manufacturing/assembling components of the fire-barrier system 100 at the factory and/or installing the fire-barrier system 100 in the field. The process 1100 may be embodied as a computer program, for example, as a stand-alone program or as a component a manufacturing/engineering design program. The process 1100 is initiated by a calling program or input at step 1130 and upon completion returns to the calling program or terminates at step 1140. The particular implementation details for a computer program embodiment will be familiar to one skilled in the art of computer software design and programming.

Reference is next made to FIG. 12, which shows exemplary design parameters presented in the form of a table 1200 for designing a fire-barrier system 100 in accordance with an embodiment of the present invention. The design parameters may be incorporated into the process 1100 described above, for example, in a computer-implemented embodiment. In another embodiment, the Table is used “on the floor” in the factory or “in the field” at an installation site. The Table 1200 includes a number of columns 1210 corresponding to wind loads, and indicated individually by references 1210a, 1210b, 1210c, 1210d, 1210e, 1210f, 1210g and 1210h. For a respective wall height, for example, 12.3 feet as indicated by column 1202, the Table 1200 comprises a number of rows, which specify design and/or dimensional elements for various component in the fire-barrier system 100. As shown, the Table 1200 includes a row 1220 for specifying the girt(s), a row 1222 for specifying the columns, a row 1224 for specifying the base plates (i.e. the footings 108 in FIG. 1), a row 1226 for specifying the anchor bolts for the base plates, a row 1228 for specifying the mid or intermediate column, a row 1230 for specifying the base plate for the intermediate column, and a row 1232 for specifying the anchor bolts for the base plate for the intermediate column.

The present invention may be embodied in other specific forms without departing from the spirit or essential characteristics thereof. Certain adaptations and modifications of the invention will be obvious to those skilled in the art. Therefore, the presently discussed embodiments are considered to be illustrative and not restrictive, the scope of the invention being indicated by the appended claims rather than the foregoing description, and all changes which come within the meaning and range of equivalency of the claims are therefore intended to be embraced therein.

What is claimed is:

1. A modular fire-barrier structure, said structure comprising:
a plurality of fire-barrier modules;
each of said fire-barrier modules including an element for adjoining a corresponding element on an adjacent fire-barrier module;
each of said fire-barrier modules including one or more panels, each of said panels comprising a fire-rated material.

2. The modular fire-barrier structure as claimed in claim 1, further including one or more columns, each of said columns being adapted for supporting said fire-barrier modules.

3. The modular fire-barrier structure as claimed in claim 2, wherein one of said columns is coupled to one of said fire-barrier modules, and another one of said columns is coupled to another one of said fire-barrier modules.

4. The modular fire-barrier structure as claimed in claim 3, further including one or more girt members, said girt member being coupled between said two columns in a substantially horizontal orientation, and said girt member including one or more brackets for coupling to one or more of said fire-barrier modules.

5. The modular fire-barrier structure as claimed in claim 4, further including a fire-resistant cover for protecting said girt member, said fire-resistant cover including a mounting bracket for coupling to said one or more of said fire-barrier modules.

6. The modular fire-barrier structure as claimed in claim 5, wherein one or more of said columns comprise a hollow member, and said hollow member is substantially filled with a fire-resistant material.

7. The module fire-barrier structure as claimed in claim 1, wherein each of said fire-barrier modules comprises a first side member, a second side member, a top member and a bottom member, said side members and said top and bottom members being connected together to form a frame, and said panel being affixed to said frame.

8. The modular fire-barrier structure as claimed in claimed 7, wherein said panels comprise a single skin formed of a fire-rated material, and said single skin material having a thickness ranging from approximately one-half inch to six inches.

9. The modular fire-barrier structure as claimed in claim 8, wherein said members and said panels are welded together as a pre-assembled unit.

10. A method for designing a fire-barrier structure, said fire-barrier structure comprising a plurality of fire-rated panels, a plurality of column elements and plurality of girt elements, said method comprising the steps of:
inputting a length parameter for said fire-barrier structure;
inputting a height parameter for said fire-barrier structure;
inputting a loading parameter;
determining a required number of said column elements based on said length parameter;
determining a required number of said girt elements based on said length and height parameters;
determining a column dimension for said column elements, said column dimension being based in part on said loading parameter; and
determining a girt dimension for said girt elements, said girt dimension being based in part on said loading parameter.
determining a thickness dimension for said fire-rated panels, said thickness dimension being based on said fire-protection parameter.

11. The method as claimed in claim 10, further including the steps of inputting a fire-protection parameter, and determining a thickness dimension for said fire-rated panels, said thickness dimension being based on said fire-protection parameter.

12. The method as claimed in claim 11, wherein said loading parameter comprises a range of expected wind speeds.

13. The method as claimed in claim 12, wherein said loading parameter comprises a range of expected seismic activity indicators.

14. The method as claimed in claim 10, wherein said loading parameter comprises a range of expected wind speeds.
